(19) United States
(12) Patent Application Publication
(10) Pub. No.: US 2019/0039934 A1
(43) Pub. Date: Feb. 7, 2019

(54) METHOD OF PRODUCING CONTROLLED MATERIAL PROPERTIES OF GLASS STRUCTURES MANUFACTURED FROM MICRON AND SUB-MICRON GLASS POWDERS AND APPLICATIONS THEREOF

(71) Applicant: The Board of Regents of The University of Texas System, Austin, TX (US)

(72) Inventors: Arturo Alejandro Fuentes, McAllen, TX (US); Kamal Sarkar, Edinburg, TX (US); Stephen Crown, Edinburg, TX (US); Horacio Vasquez, Edinburg, TX (US)

(21) Appl. No.: 16/051,703

(22) Filed: Aug. 1, 2018

Related U.S. Application Data
(60) Provisional application No. 62/539,598, filed on Aug. 1, 2017.

(51) Int. Cl. C03B 19/10; C03B 19/06

(52) U.S. Cl. CPC C03B 19/1095; C03B 19/06; C03B 19/1085

(57) ABSTRACT

Described herein is a method of preparing glass structures having tunable material properties. By varying process conditions, physical, thermal, optical, electrical, and mechanical properties of the glass particles can be altered in a predictable manner. By varying porosity, density, and pore structures, for example, a wide range of physical, thermal, optical, electrical, and mechanical characteristics of micron and nanometer sized glass particles can be achieved and/or modified.

### PRIORITY CLAIM

This application claims priority to U.S. Provisional Application Ser. No. 62/539,598 entitled “METHOD OF PRODUCING CONTROLLED MATERIAL PROPERTIES OF GLASS STRUCTURES MANUFACTURED FROM MICRON AND SUB-MICRON GLASS POWDERS AND APPLICATIONS THEREOF” filed Aug. 1, 2017, which is incorporated herein by reference in its entirety.

### BACKGROUND OF THE INVENTION

### 1. Field of the Invention

The invention generally relates to methods of altering the material properties of glass nano- and micro-particles. More particularly, the invention relates to methods of altering the material properties of glass structures manufactured from micron and sub-micron waste glass powders. The invention also includes many exemplary, non-limiting, applications based on some selected material properties.

### 2. Description of the Relevant Art

Glass has been a very useful material for the community, from everyday use (e.g., a glass cup) to innovative art purposes. The history of the glass began about 3500 BCE (Before Common Era) in Mesopotamia, where archaeological evidence suggests the first true glass was made. The scientific name used to refer to the glass is silica dioxide (SiO₂). Nanosize glass particles (e.g., 10⁻⁹ m) are used for construction purposes. For example, some companies produce tiles made of nano crystalized glass and others just produce the nano-sized glass particles.

The competitive products that were compared were just the nano glass powders, because there are not any companies, that we are aware of, that produce glass nano porous structures. The comparison of the competitive products is shown in Table 1.

TABLE 1

| | US Research | | | | | | | |
|---|---|---|---|---|---|---|---|---|
| | Nanomaterials | | NanoAmor | | MTI, Co. | | Mk NANO | |
| Crystallographic | Amorphous | | Amorphous | | Amorphous | | Amorphous | |
| Structure | | | | | | | | |
| Porosity | Nonporous | | Not Specified | | Not Specified | | Not Specified | |
| Purity | 99.5+% | | >99% | | 99% | | 99.5% | |
| Average Particle | 15-20 | nm | 80 | nm | 100 | nm | 15 | nm |

| Size | Spherical particles | | Spherical particles | | | | |
|---|---|---|---|---|---|---|---|
| SSA | 170-200 | m²/g | Not Specified | 440 | m²/g | 650 | m²/g |

| Color | White | | White | | White | | White |
|---|---|---|---|---|---|---|---|
| Bulk Density | <10 | g/cm³ | 0.63 | g/cm³ | 0.63 | g/cm³ | Not Specified |
| True Density | 2.4 | g/cm³ | 2.2-2.6 | g/cm³ | 2.2-2.6 | g/cm³ | Not Specified |

| UVA | >75% | Not Specified | | Not Specified | Not Specified | |
|---|---|---|---|---|---|---|
| Reflectivity | | | | | | |
| Melting Point | Not Specified | 1610-1728° | C. | Not Specified | 1610-1728° | C. |

### SUMMARY OF THE INVENTION

In one embodiment, a method of preparing glass particles having predetermined physical properties includes: obtaining glass particles having a particle size of less than about 50 microns; and sintering and/or localized melting of glass particles of various particle sizes at a predetermined temperature and a predetermined pressure for a predetermined amount of time such that the physical properties of the glass particles are altered. In some embodiments, the predetermined temperature is greater than about 500° C. In preferred embodiments, the predetermined temperature is between about 700° C. and about 1000° C. The predetermined amount of time is typically greater than about 1 hour. In preferred embodiments, the predetermined amount of time is between about 1 hour to about 7 hours.

In some embodiments, the glass particles are packed into a mold by applying pressure to the glass particles. Pressure may be applied to the glass particles by placing a load on the glass particles during sintering.

The glass particles, initially, have an average equivalent diameter of between about 100 nm to about 10 microns. The glass particles, initially, may have an average diameter of between about 10 microns and about 50 microns.

In an embodiment, the sintering is performed under a controlled environment. For example, sintering may be performed under an air atmosphere, an inert atmosphere (e.g., nitrogen or argon), or under a vacuum.

In an embodiment, the method further comprises drying the glass particles by heating the glass particles at a temperature between about 100° C. and 300° C. for a time of between about 1 hour and 5 hours, prior to sintering. In an embodiment, the method further comprises cooling the particles after sintering at a controlled cooling rate.

In an embodiment, the method may alter the density of the glass particles. The method may also alter the pore size and/or porosity of the glass particles.

Glass particles made by the method set forth above may be used for a number of applications. For example, a method of adsorption/absorption of compounds includes applying sintered glass particles to the fluid or area being treated. Examples of specific adsorption/absorption of compounds include applying sintered glass particles to the fluid or area being treated. Examples applications include filtration, environmental clean-up, flash flood pavements, etc.

In an embodiment, sintered glass particles may be used to form structures with controlled thermal properties. Exemplary structures include thermal barriers, building materials (roof tile as an example), oven walls, etc.

In an embodiment, sintered glass particles may be used as light weight (lighter than water) offshore structures, building materials (wall as an example), etc. The sintered glass particles may be formed under processing conditions that promote the formation of particles having a density less than the density of water.

In some embodiments, sintered glass particles may be formed using processing conditions that promote various energy densities. In some embodiment, the sintered glass particles may be used to form energy absorbing structures like road blocks, controlled release chemicals, etc.

In some embodiments, sintered glass particles may be used for removing certain hazardous and environmentally adverse fluids by using the ability of sintered glass particles to absorb many fluids and mixtures and its inherent ability to chemical resistance.

In some embodiments, sintered glass particles, may be used for controlled release of certain fluids and mixtures using the intrinsic absorption/adsorption properties of the particles.

In some embodiments, glass structures with controlled optical characteristics may be formed by the methods described above. In some embodiments, the optical characteristics comprise color of the glass structure.

In some embodiment, glass structures with controlled electrical characteristics may be formed by the methods described above. In some embodiments, the controlled electrical characteristics comprise insulation properties. In some embodiments, the controlled electrical characteristics comprise conductive properties.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts the effect of processing temperature on density and porosity;

FIG. 2 shows an SEM picture of a material having an average porosity of 250 μm;

FIG. 3 shows an SEM picture of a material having an average porosity of 70 μm;

FIG. 4 shows an SEM picture of a material having an average porosity of 15 μm;

FIG. 5 depicts a graph of the effect of pore size on the absorption of water;

FIG. 6 depicts a graph of the effect of pore size on the void space fill;

FIG. 7 depicts a graph of the effect of pore size on peak stress;

FIG. 8 depicts a graph of the effect of pore size on thermal conductivity; and

FIGS. 9A and 9B depict SEM (Scanning Electron Microscope) pictures showing single digit micron size pores from glass particles processed at 650° C.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Described herein is a process to control materials properties without changing the chemistry of a specific material, namely, soda lime glass. Controlling material properties imply, at minimum, physical properties (density, solubility, etc.), thermal properties, mechanical properties, optical properties, the ability to store energy via effects like surface tension, capillary action, geometric effects, etc.

In one embodiment, a method of preparing glass particles having predetermined physical properties includes: obtaining glass particles having a particle size of less than about 50 microns; and sintering the glass particles at a predetermined temperature and a predetermined pressure for a predetermined amount of time such that the physical properties of the glass particles are altered.

The glass particles may be obtained from commercial manufacturers, or may be produced from waste glass. When obtained from waste glass, the collected waste glass is cleaned to remove typical contaminants like dirt, oil, etc. using appropriate chemicals like surfactants and water. After cleaning, waste glass is dried before processing. In an embodiment, the method further comprises drying the glass particles by heating the glass particles at a temperature between about 100° C. and 300° C. for a time of between about 1 hour and 5 hours, prior to sintering. A typical drying process, for about 10 pounds of glass, is to dry the glass at about 300° C. for about 3 hours. The waste glass may be stirred (continuously or periodically) to ensure complete dryness. The dried waste glass may be converted to micron and sub-micron (nano-) glass particles (e.g., using a milling process). The typical range of the produced glass particles can be anywhere from 100 nm to single digit micron. Glass sizes can be smaller than 100 nm or larger than 10 microns and in the range of 10 to 50 micron or more.

Prior to sintering, the glass particles may be dried by heating the glass particles at a temperature between about 100° C. and 300° C. for a time of between about 1 hour and 5 hours to ensure the particles are dry before sintering.

The dried glass micro- or nanoparticles were sintered after drying. The process parameters used to change the material properties of the glass particles during sintering include, but are not limited to, temperature, pressure (above or below ambient), and time. The actual value of these parameters depends on the particle size distribution of the starting glass particles and the final desired material properties of the sintered glass particles (e.g., the final density of the sintered glass particles).

With regard to temperature, typical temperatures used during the sintering process, are greater than about 500° C. In preferred embodiments, the predetermined temperature may be in the range between about 600° C. to about 1000° C. In some embodiments, the sintering temperature may be above 1000° C.

With regard to time, the predetermined amount of time is typically greater than about 1 hour. In preferred embodiments, the predetermined amount of time is between about 1 hour to about 7 hours.

With regard to pressure, the glass particles may be sintered under pressure or in the absence of pressure. In some embodiment, the glass particles are packed into a mold by applying pressure to the glass particles and sintered. Pressure may also be applied to the glass particles by placing a load on the glass particles during sintering.

In an embodiment, the sintering is performed under a controlled environment. For example, sintering may be performed under an air atmosphere, an inert atmosphere (e.g., nitrogen or argon), or under a vacuum.

In an embodiment, the method further comprises drying the glass particles by heating the glass particles at a temperature between about 100 C and 300 C for a time of between about 1 hour and 5 hours, prior to sintering. In an embodiment, the method further comprises cooling the particles after sintering at a controlled cooling rate.

In an embodiment, the method may alter the density of the glass particles. The method may also alter the pore size and/or porosity of the glass particles.

Using these process parameters (pressure, temperature, time, environment, and size distribution of glass particles) a wide range of density and attendant variation of the physical, mechanical, and thermal properties has been achieved. Lighter than water structures (0.2 gm/cc as a non-limiting example) to almost as dense as glass (2.4 grams/cc) glass particles have been obtained. Using this process, a wide range of glass particles having varied densities and attendant diverse material properties like thermal, mechanical, and physical as non-limiting examples.

Glass particles made by the method set forth above may be used for a number of applications. For example, a method of adsorption/absorption of compounds includes applying sintered glass particles to the fluid or area being treated. Examples of specific adsorption/absorption of compounds include applying sintered glass particles to the fluid or area being treated. Examples applications include filtration, environmental clean-up, flash flood pavements, etc.

In an embodiment, sintered glass particles may be used to form structures with controlled thermal properties. Exemplary structures include thermal barriers, building materials (roof tile as an example), oven walls, etc.

In an embodiment, sintered glass particles may be used as light weight (lighter than water) offshore structures, building materials (wall as an example), etc. The sintered glass particles may be formed under processing conditions that promote the formation of particles having a density less than the density of water.

In some embodiments, sintered glass particles may be formed using processing conditions that promote various energy densities. In some embodiment, the sintered glass particles may be used to form energy absorbing structures like road blocks, controlled release chemicals, etc.

In some embodiments, sintered glass particles may be used for removing certain hazardous and environmentally adverse fluids by using the ability of sintered glass particles to absorb many fluids and mixtures and its inherent ability to chemical resistance.

In some embodiments, sintered glass particles, may be used for controlled release of certain fluids and mixtures using the intrinsic absorption/adsorption properties of the particles.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Making Controlled Nano-Porous Micron and Sub-Micron Structures Using Temperature, Pressure, and Packing Density as Process Variables.

Making controlled nano-porous micron and sub-micron structures was the objective of this experiment. Glass particles (from recycled glass) were placed in an oven for 1 hour and heated to 900° C. Glass structures were produced from the glass particles at that temperature. Further experiments were performed in which the pressure, temperature, time, and density of the material used was varied. To conduct these experiments, the glass particles were placed inside two metal plates. The plates had to be of metal to resist the high processing temperatures. Eight plates were made with a 1 inch hole in the middle. The plates were cut in half to allow easy extraction of the glass structure from the inside. A clamp was used to hold the plates together inside the oven when the glass powder is placed between the plates.

In the first experiment three samples were made (Samples 1, 2, and 3). 21.23 grams of powder was used for the first specimen. As soon as the powder was inside the plates, a metal bar was used to apply pressure to the powder. The metal bar reduced the spacing by 0.25 inches (referred to as a packing height of 0.25 inches). The bar also was left in place and went inside the oven with the plates to ensure pressure remained on the plates. The second sample was of 16.1 grams of powder. Then the packing height applied to it was 0.5 inches. Also the metal bar was left in place inside the oven with the second sample. The oven was placed at 900° C. and both samples (Samples 1 and 2) stayed inside for 1 hour. The third sample was of 40 grams of powder. The packing height applied to it was 1 in. The third sample went inside the oven with the bar on top for 2 hours at 1150° C. The following table, Table 2, show the specifications for making each of the Samples 1-3.

TABLE 2

| | Weight of | | Packing | | | |
|---|---|---|---|---|---|---|
| | powder | Diameter | Height | Time | Temp | Length |
| Sample | (g) | (in) | (in) | (hours) | (° C.) | (in) |
| 1 | 21.23 | 1 | 0.25 | 1 | 900 | 1.45 |
| | | | | hour | | |
| 2 | 16.1 | 1 | 0.5 | 1 | 900 | 1.1 |
| | | | | hour | | |
| 3 | 40 | 1 | 1 | 2 | 1150 | 1.22 |
| | | | | hours | | |

After sintering, each sample was allowed to cool for 8 hours. From pictures taken of the samples, a difference in pore size can be seen. As pressure is increased (increase in packing height) the pores become smaller due to the increase in pressure.

Another experiment was made with three samples kept at the same temperature and time inside the oven. The pressure and the quantity of powder for each sample was varied. Three samples were made: the first sample with no pressure, the third sample with full pressure, and the second sample at half the pressure of the third sample. The first sample, with no pressure applied, used 6.6 grams of glass powder. The second sample needed more powder for better packing. The amount of powder used for the sedond sample was 9.55 grams. The third sample was fully packed at full pressure. The amount of powder used in the third sample was 13 grams. The three samples went inside of the oven for 1 hour at 900° C. The samples were left inside the oven with no cap. The result was that the samples tend to expand at high temperatures depending on the packing. This resulted in samples having an appearance of a mushroom.

We tested the effect of rapid cooling on the samples structure. To cool down the samples, oil was used. The use of oil also helped to loosen the bolts in the clamp. Another benefit of using oil was that it helps to take out the samples from the clamp.

To prevent the formation of mushroom-like structures, a cap was placed on the top of the molds. The same procedure was used with the first sample without pressure, the second with half pressure and the third with full pressure. The amount of powder used was 5 grams for the first sample, 7.5 grams for the second sample, and 9.8 grams for the third sample. Pressure was produced by placing a load (e.g., a weighted object) on the powders. These experiments were done to see the effect of pressure on packing.

The structures formed had an average pore size of 450 microns and 250 microns depending on the packing and the initial density. As shown in Table 3, as the pressure is increased, the average pore size decreases.

TABLE 3

| | | Temperature | | | | | | | | | | Final | Final |
|---|---|---|---|---|---|---|---|---|---|---|---|---|---|
| | time | degrees | Weight | Volume | Density | | | % of | | Avg. | Range of | Volume | Density |
| Cap? | (hours) | celsius | (g) | (cc) | gm/cm3 | Minimum | Maximum | glass | Void % | Pore Size | pore size | cm3 | g/cm3 |
| No | 1 | 900 | 6.6 | 7.7 | 0.86 | 350 | 550 | 32.1 | 67.9 | 450 | 200 | 8.55 | 0.77 |
| No | 1 | 900 | 9.5 | 7.7 | 1.23 | 300 | 400 | 33.8 | 66.3 | 350 | 100 | 11.7 | 0.81 |
| No | 1 | 900 | 13 | 7.7 | 1.7 | 200 | 300 | 26.3 | 73.8 | 250 | 100 | 20.48 | 0.63 |

The same experiment was performed, but adding a cap to each sample at 900° C. and 1 hour in the oven. This structures formed had an average pore size of 265 microns and 75 microns depending on the packing and the initial density. As shown in Table 4, as the pressure is increased, the average pore size decreases.

TABLE 4

| | | Temperature | | | | | | | | | | Final | Final |
|---|---|---|---|---|---|---|---|---|---|---|---|---|---|
| | time | degrees | Weight | Volume | Density | | | % of | | Avg. | Range of | Volume | Density |
| Cap? | (hours) | celsius | (g) | (cc) | gm/cm3 | Minimum | Maximum | glass | Void % | Pore Size | pore size | cm3 | g/cm3 |
| Yes | 1 | 900 | 5.3 | 6.39 | 0.83 | 200 | 330 | 34.2 | 65.8 | 265 | 130 | 7.7 | 0.82 |
| Yes | 1 | 900 | 7.5 | 6.39 | 1.17 | 100 | 200 | 33.3 | 66.7 | 150 | 100 | 9.34 | 0.8 |
| Yes | 1 | 900 | 9.8 | 6.39 | 1.53 | 40 | 100 | 35.0 | 65.0 | 70 | 60 | 11.63 | 0.84 |

In another experiment a cap was used on each sample. The processing parameters were 1100° C. and 3 hours in the oven. This experiment gave an average pore size of 55 microns and 14 microns depending on the packing and the initial density. As shown in Table 5, as the pressure is increased, the average pore size decreases. Using a cap, and the full packed mold, produced a white structure. After detaching from the clamp, the white structure was broken using a hammer and a screwdriver. The resulting product has different properties.

TABLE 5

| | | Temperture | | | | | | | | | | Final | Final |
|---|---|---|---|---|---|---|---|---|---|---|---|---|---|
| | time | degrees | Weight | Volume | Density | | | % of | | Avg. | Range of | Volume | Density |
| Cap? | (hours) | celsius | (g) | (cc) | gm/cm3 | Minimum | Maximum | glass | Void % | Pore Size | pore size | cm3 | g/cm3 |
| Yes | 3 | 1100 | 5 | 5.47 | 0.91 | 30 | 80 | 30.8 | 69.2 | 55 | 50 | 6.79 | 0.74 |
| Yes | 3 | 1100 | 7 | 5.47 | 1.27 | 25 | 45 | 32.9 | 67.1 | 35 | 20 | 8.86 | 0.79 |
| Yes | 3 | 1100 | 9 | 5.47 | 1.64 | 8 | 20 | 25.4 | 74.6 | 14 | 12 | 14.79 | 0.61 |

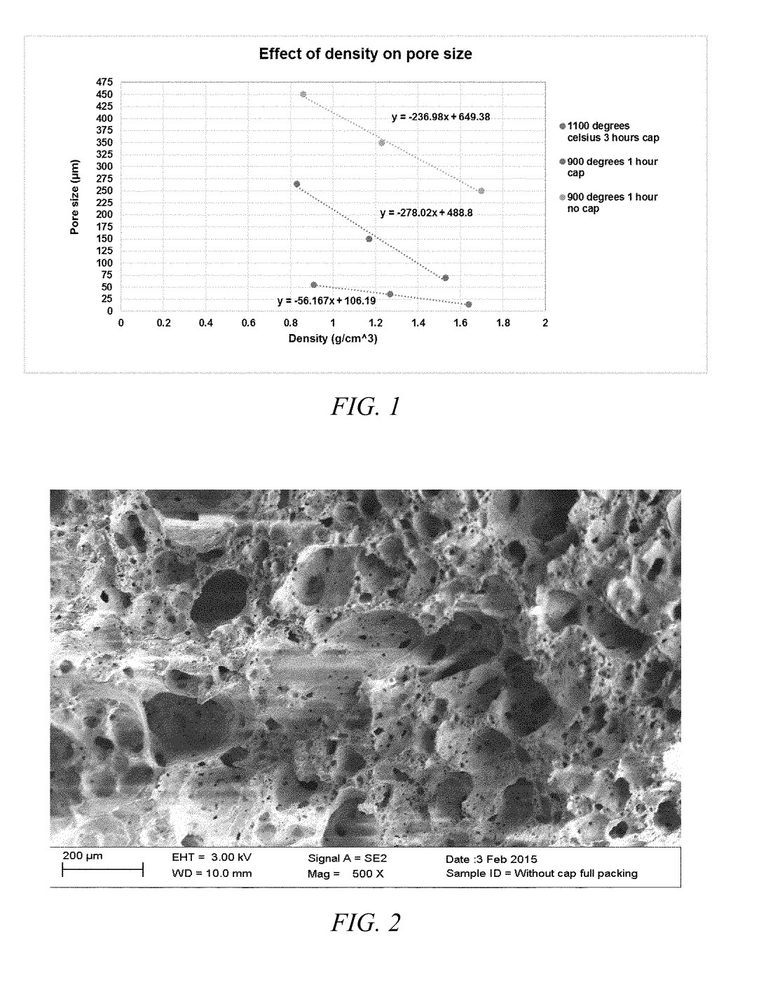

FIG. 1 shows 3 different experiments with different parameters. The top line represents a sample prepared at 900° C. and 1 hour with no cap. The middle line represents a sample prepared at 900° C. and 1 hour with a cap. The lower line represents a sample prepared at 1100° C. and 3 hours with a cap. These experiments show how the porosity can be changed to range from 450 microns to 15 microns by varying the production parameters.

### SEM Pictures

FIG. 2 shows an SEM picture of a material having an average porosity of 250 μm. In order to achieve this porosity the process parameters are: 900° C.; 1 hour; No Cap (mushroom effect); ATM Pressure; Full packing; 13 grams nanopowder.

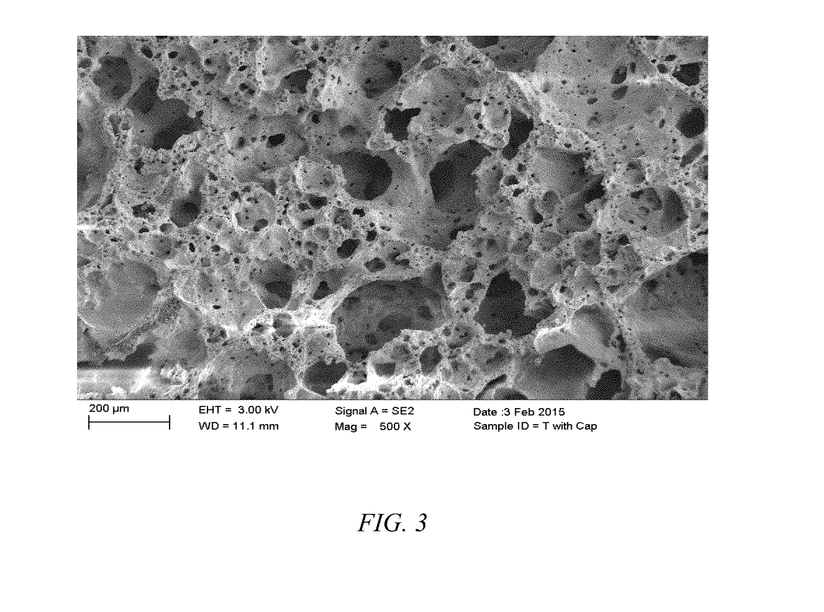

FIG. 3 shows an SEM picture of a material having an average porosity of 70 μm. In order to achieve this porosity the process parameters are: 900° C.; 1 hour; Capped; Full packing; and 9.8 grams of nanopowder.

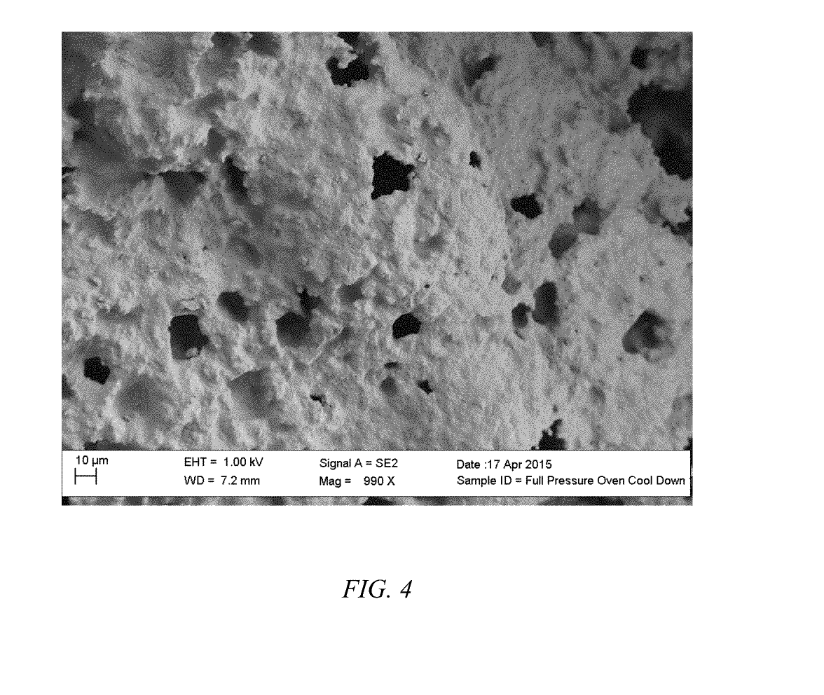

FIG. 4 shows an SEM picture of a material having an average porosity of 15 μm. In order to achieve this porosity the process parameters are: 1100° C.; 3 hour; Capped; Full packing; 9.8 grams of nanopowder.

### Water Absorption

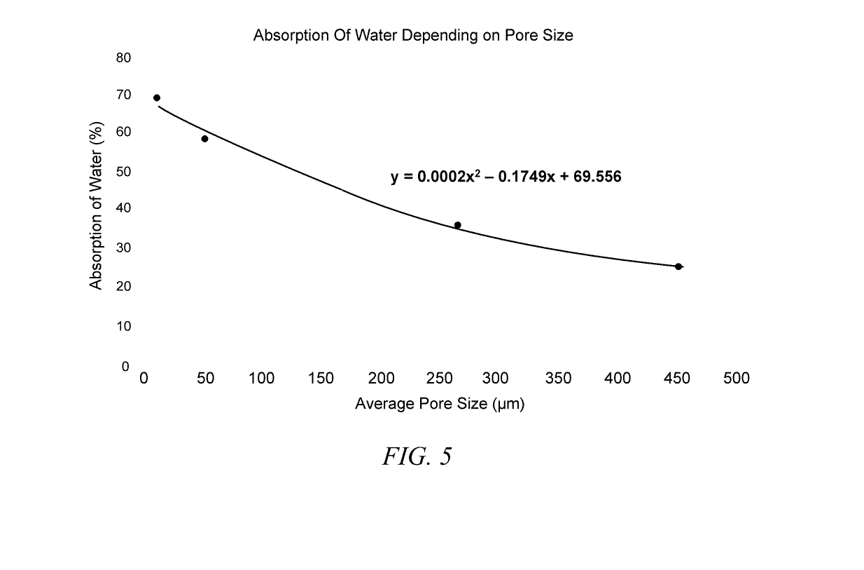

An experiment was performed with samples having different pore sizes to see the effect of pore size on the absorption of water. FIG. 5 depicts the results of these experiments. This experiment shows that as the pore size decreases the sample absorbs more water. This can be very helpful if we want to use this process to produce materials for filtration of water. The data generated from this experiment is summarized in Table 6.

TABLE 6

| Pore Size (μm) | Absorption of Water (%) |
|---|---|
| 450 | 25 |
| 265 | 36 |
| 55 | 58 |
| 14 | 69 |

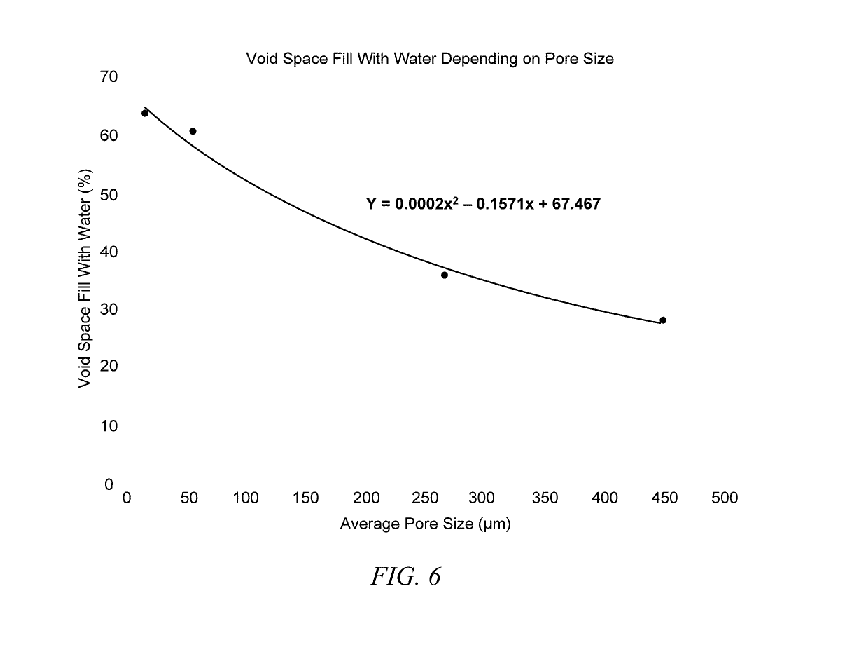

FIG. 6 shows the void space fill with water depending on pore size. The data generated from this experiment is summarized in Table 7.

TABLE 7

| Pore Size (μm) | Void Space Fill with Water (%) |
|---|---|
| 450 | 28 |
| 265 | 36 |
| 55 | 61 |
| 14 | 64 |

### Compression Test

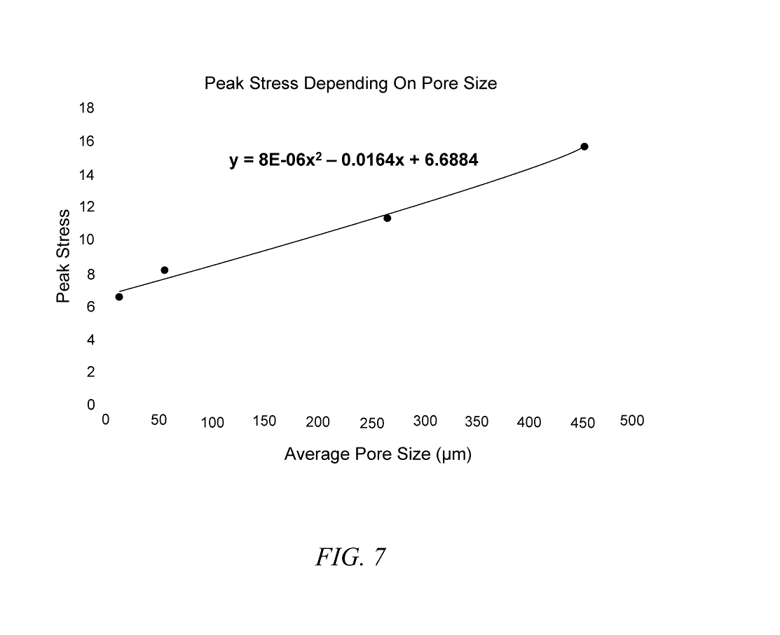

An experiment was performed with samples having different pore sizes to determine the peak stress of each sample. The results are depicted in FIG. 7 and the data collected summarized in Table 8.

TABLE 8

| Avg. Pore Size | Diameter | Area | Peak Load | Peak Stress |
|---|---|---|---|---|
| (μm) | (mm) | (mm²) | (N) | (MPa) |
| 450 | 23.62 | 438.17 | 6872.7 | 15.68 |
| 265 | 25.66 | 517.13 | 5862.37 | 11.36 |
| 55 | 25.36 | 505.11 | 4154.02 | 8.22 |
| 14 | 25.84 | 524.41 | 3388.89 | 6.46 |

As can be seen form this data, as the pore size decreases, the peak stress also decreases.

### Thermal Test

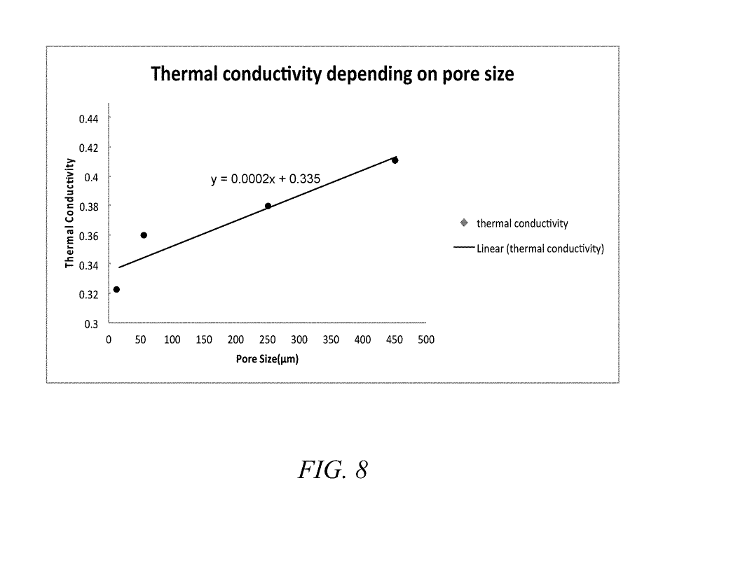

An experiment was performed with samples having different pore sizes to see the thermal conductivity and specific heat of each sample. The results are depicted in FIG. 8 and the data collected summarized in Table 9.

TABLE 9

| Pore Size (μm) | K |
|---|---|
| 450 | 0.41117 |
| 250 | 0.380179 |
| 55 | 0.35994 |
| 14 | 0.32285 |

This data shows that as the average pore size decreases the thermal conductivity tends to decrease. It is believed that when the pore size is very small the pores are interconnected and the heat doesn't expand. This information may be useful for determining the processing parameters for creating a thermal barrier.

### Temperature Effects on Processing of Glass Powders

The effect of temperature on the processing of glass powders was investigated. In these experiments the lowest temperature used was 650° C. and highest was 800° C. Table 10 shows the details of the processing conditions for each experiment and the physical properties of the obtained glass particles. In Table 10, “Sub” means sub-microns typically in the range of 500+/−200 nanometers. “Single Digit” means single digit micron size glass particles (1 to 9 microns) obtained from waste glass. The “Single Digit” materials were obtained from a Canadian company called Verglass in tens of pounds. “Sub” glass particles, being commercially obtained, give a better quality glass particle as the starting material, and give better products at a lower temperature. On the other hand, “Single Digit” (1 to 9 microns) glass particles are relatively inferior starting materials and typically needs higher temperatures to process.

TABLE 10

| | Particle | Temper- | | | | |
|---|---|---|---|---|---|---|
| | Size | ature | Time | Density | Porosity | |
| Exp. # | (μm) | (° C.) | (hour) | (g/cm3) | (%) | Color |
| 1 | Sub | 650 | 1.0 | 1.9 | 79 | Gray |
| 2 | Sub | 700 | 1.0 | 2.2 | 92 | Light |
| | | | | | | Green |
| 3 | Single Digit | 800 | 1.5 | 2.3 | 96 | White |
| 4 | Single Digit | 775 | 1.0 | 1.82 | 76 | White |
| 5 | Single Digit | 750 | 1.0 | 1.11 | 46.25 | Off |
| | | | | | | White |

All samples were nominally packed typically with 50 grams of glass powders. No additional powders or packing was used to densify the powders. The oven was kept at normal atmospheric pressure and conditions without any vacuum and/or other gases. All samples were processed after the oven reached the target temperature. All samples were cooled in the oven.

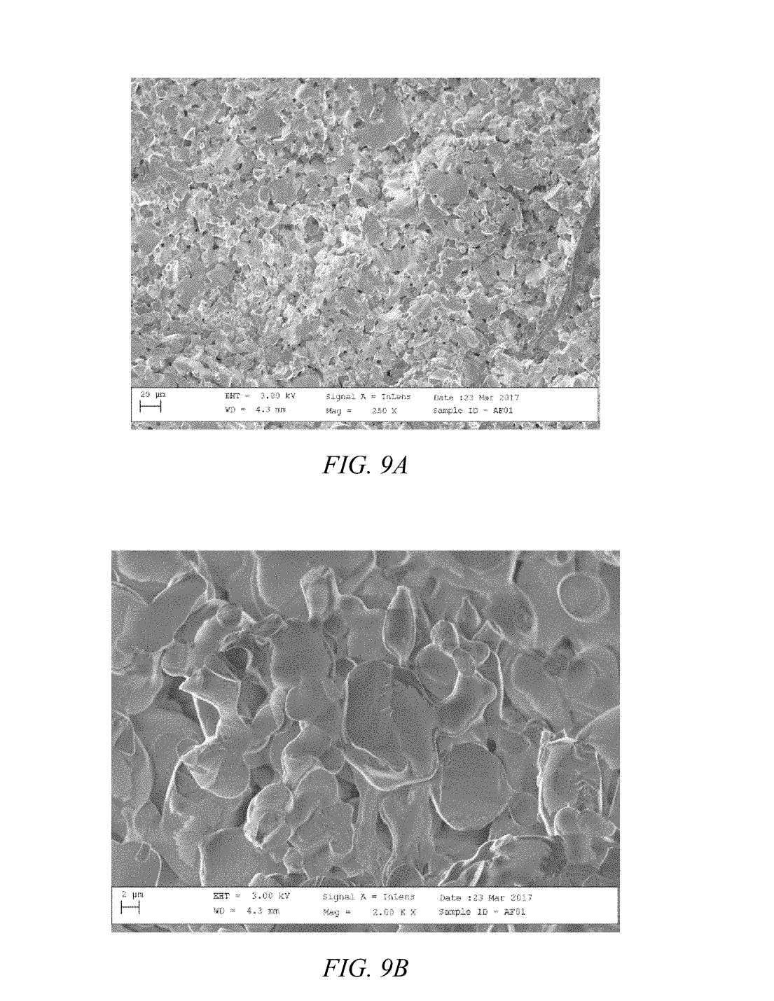

FIGS. 9A and 9B depict some typical SEM (Scanning Electron Microscope) pictures showing single digit micron size pores from 650° C. with our materials that are sub-micron glass particles. FIG. 9A has a scale bar of 20 microns showing single digit pore sizes that are magnified in picture of FIG. 9B, which has a scale of 2 microns. In both FIGS. 9A and 9B the pores appear as black dots/holes.

### Further Effects of Process Parameters on Physical Properties

In another test, glass particles were processed by placing glass powders (micron size) in a furnace at 950° C. for 30 to 40 minutes. Powders were manually pressed 10 to 15 times in a 4″ terra cotta pot. Typical weight of glass powders processed in the oven for each sample was about 160 grams. Different diameter samples were prepared using the above processing conditions and each sample was identified by final sample diameter and the properties of each sample are reported in Table 11.

TABLE 11

| | | | | Thermal | |
|---|---|---|---|---|---|
| | Mass | Volume | Density | Conductivity | |
| Sample | (kg) | (m³) | (kg/m³) | (W/m*K) | Porosity |
| 0.25 in | 0.0063 | 8.03E−6 | 784.55 | 1.5616 | 0.67 |
| 0.5 in | 0.0103 | 1.606E−5 | 641.34 | 1.1154 | 0.73 |
| 0.75 in | 0.0143 | 2.409E−5 | 593.607 | 0.7098 | 0.75 |
| 1.0 in | 0.0183 | 3.212E−5 | 569.738 | 0.3003 | 0.76 |
| Clay | 0.17271 | 8.96E−05 | 1927.566 | 0.186197 | 0.27 |

### CONCLUSION

Temperature dependence of density, as an example, is an over-simplification of the data. Density and other similar physical/thermal/mechanical properties depend on a number controllable process parameters, namely, size distribution of starting material, chemical composition (even within soda lye glass), packing density, pressure on the mold (in addition to packing density), environment (including vacuum), temperature, time, heating and cooling rates, (oven) environment, etc. Once any of these parameters are changed, the properties of the various samples may be dramatically influenced. Many physical, thermal, mechanical, optical, electrical, etc. properties may be varied by varying any of the process parameters and/or many combinations thereof. Based on extensive testing some general observations were observed. For example, higher temperatures or higher packing density generally results in higher density. However, starting materials, environmental conditions, heating/cooling rate, time, etc. can dramatically change/invert many of these general observations. In summary, all these proposed process parameters (temperature, pressure, time, environment, & starting distribution of glass particles, & amount of starting materials, among others) control the final porous structure and resulting material properties. While the process is not fully understood and/or can be quantified, the basic mechanisms include, we believe, sintering, localized melting, and high temperature diffusion.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of preparing glass structures having predetermined material properties comprising:
obtaining glass particles having a particle size distribution of less than about 50 microns;
heating the glass particles at a predetermined temperature and a predetermined pressure for a predetermined amount of time such that the physical properties of the glass particles are altered.

2. The method of claim 1, wherein heating the glass particles comprises heating to a temperature such that localized melting of the glass particles occurs.

3. The method of claim 1, wherein the predetermined temperature is greater than about 500° C.

4. The method of claim 1, wherein the predetermined temperature is between about 600° C. and about 1000° C.

5. The method of claim 1, wherein the predetermined temperature is over about 1000° C.

6. The method of claim 1, wherein the time is greater than about 1 hour.

7. The method of claim 1, wherein the time is between about 1 hour to about 7 hours.

8. The method of claim 1, wherein the glass particles are packed into a mold by applying pressure to the glass particles.

9. The method of claim 1, wherein pressure is applied to the glass particles by placing a load on the glass particles during sintering.

10. The method of claim 1, wherein the glass particles have an average diameter of between about 100 nm to about 10 microns.

11. The method of claim 1, wherein the glass particle have an average diameter of between about 10 microns and about 50 microns.

12. The method of claim 1, wherein the heating is performed under a controlled environment.

13. The method of claim 1, wherein the heating is performed under a vacuum.

14. The method of claim 1, further comprising drying the glass particles by heating the glass particles at a temperature between about 100° C. and 300° C. for a time of between about 1 hour and 5 hours.

15. The method of claim 1, further comprising cooling the particles after sintering at a controlled cooling rate.

16. The method of claim 1, wherein the physical property of the glass particles that is altered is the density of the glass particles.

17. The method of claim 1, wherein the physical property of the glass particles that is altered is the pore size and/or porosity of the glass particles.

18. Glass structures having predetermined material properties made by the process comprising:
obtaining glass particles having a particle size distribution of less than about 50 microns;
heating the glass particles at a predetermined temperature and a predetermined pressure for a predetermined amount of time such that the physical properties of the glass particles are altered.

19-21. (canceled)
